(19) United States
(12) Patent Application Publication
(10) Pub. No.: US 2024/0196155 A1
(43) Pub. Date: Jun. 13, 2024

(54) Apparatus, Methods and Computer Programs for Providing Spatial Audio Content

(71) Applicant: Nokia Technologies Oy, Espoo (FI)

(72) Inventor: Lasse Juhani LAAKSONEN, Tampere (FI)

(21) Appl. No.: 18/553,879

(22) PCT Filed: Mar. 11, 2022
(86) PCT No.: PCT/FI2022/050154

§ 371 Date: Oct. 4, 2023

(30) Foreign Application Priority Data
Apr. 7, 2021 (GB) 2104921.8

(51) Int. Cl. H04S 7/00

(52) U.S. Cl. CPC H04S 7/303; H04R 2227/005; H04S 2400/11

(57) ABSTRACT

Examples of the disclosure relate to maintaining spatial audio continuity in a combined space. In examples of the disclosure there is provided an apparatus including circuitry for: determining a first spatial audio configuration for at least a first space including a first acoustic rendering arrangement and determining a second spatial audio configuration for at least a second space including a second acoustic rendering arrangement; and determining a combined spatial audio scene for a combined space including at least the first space and the second space. The combined spatial audio scene is based on the first spatial audio configuration and the second spatial audio configuration and wherein the combined spatial audio scene is configured to maintain spatial audio continuity in response to a user position changing from the first space to the second space.

### TECHNOLOGICAL FIELD

Examples of the disclosure relate to apparatus, methods and computer programs for providing spatial audio content. Some relate to apparatus, methods and computer programs for providing spatial audio content using a plurality of different acoustic rendering arrangements.

### BACKGROUND

Spatial audio can be provided to a user by using different acoustic rendering arrangements. For example, a home or office can be configured with different acoustic rendering arrangements in different rooms. The different acoustic rendering arrangements can have different spatial audio playback properties and capabilities. This can lead to a discontinuous spatial audio experience for a user as they move between rooms or where there are a plurality of users located in different rooms.

### BRIEF SUMMARY

According to various, but not necessarily all, examples of the disclosure there is provided an apparatus comprising means for:
determining a first spatial audio configuration for at least a first space comprising a first acoustic rendering arrangement and determining a second spatial audio configuration for at least a second space comprising a second acoustic rendering arrangement; and
determining a combined spatial audio scene for a combined space comprising at least the first space and the second space wherein the combined spatial audio scene is based on the first spatial audio configuration and the second spatial audio configuration and wherein the combined spatial audio scene is configured to maintain spatial audio continuity in response to a user position changing from the first space to the second space.

The means may be for enabling playback of spatial audio signals using the combined spatial audio scene in at least the first space and the second space.

The spatial audio continuity may be maintained by at least one of: reducing differences in a main orientation for spatial audio between the first space and the second space, maintaining spatial audio source direction accuracy, maintaining spatial audio energy balance between directions.

The spatial audio configurations may comprise a main orientation for a user listening to spatial audio in the corresponding space.

The combined spatial audio scene may be determined based on one or more orientation measures where the orientation measures provide an indication of spatial audio quality at different orientations for a user within the different spaces.

The combined spatial audio scene may be determined based on one or more deviation values that provide an indication of an allowed difference in spatial audio scenes between the first space and the second space.

The combined spatial audio scene may be determined based on tracking data relating to one or more users.

The combined spatial audio scene may be determined based on data indicating the type of content being provided.

The means may be for determining spatial audio configurations for a plurality of different spaces comprising different acoustic rendering arrangements and determining a combined spatial audio scene for a combined space comprising the plurality of spaces wherein the combined spatial audio scene is based on the spatial audio configurations for the plurality of different spaces.

The combined spatial audio scene may be determined by applying different weightings to different spaces.

The different spaces may comprise different rooms.

According to various, but not necessarily all, examples of the disclosure there is provided an apparatus comprising at least one processor; and at least one memory including computer program code, the at least one memory and the computer program code configured to, with the at least one processor, cause the apparatus at least to perform:
determining a first spatial audio configuration for at least a first space comprising a first acoustic rendering arrangement and determining a second spatial audio configuration for at least a second space comprising a second acoustic rendering arrangement; and
determining a combined spatial audio scene for a combined space comprising at least the first space and the second space wherein the combined spatial audio scene is based on the first spatial audio configuration and the second spatial audio configuration and wherein the combined spatial audio scene is configured to maintain spatial audio continuity in response to a user position changing from the first space to the second space.

A system device comprising an apparatus as described herein.

The system device may be any one of: a smartphone, a home server, a cloud service.

According to various, but not necessarily all, examples of the disclosure, there may be provided a method comprising:
determining a first spatial audio configuration for at least a first space comprising a first acoustic rendering arrangement and determining a second spatial audio configuration for at least a second space comprising a second acoustic rendering arrangement; and
determining a combined spatial audio scene for a combined space comprising at least the first space and the second space wherein the combined spatial audio scene is based on the first spatial audio configuration and the second spatial audio configuration and wherein the combined spatial audio scene is configured to maintain spatial audio continuity in response to a user position changing from the first space to the second space.

According to various, but not necessarily all, examples of the disclosure, there may be provided a computer program comprising computer program instructions that, when executed by processing circuitry, cause:
determining a first spatial audio configuration for at least a first space comprising a first acoustic rendering arrangement and determining a second spatial audio configuration for at least a second space comprising a second acoustic rendering arrangement; and
determining a combined spatial audio scene for a combined space comprising at least the first space and the second space wherein the combined spatial audio scene is based on the first spatial audio configuration and the second spatial audio configuration and wherein the combined spatial audio scene is configured to maintain spatial audio continuity in response to a user position changing from the first space to the second space.

### BRIEF DESCRIPTION

Some examples will now be described with reference to the accompanying drawings in which:

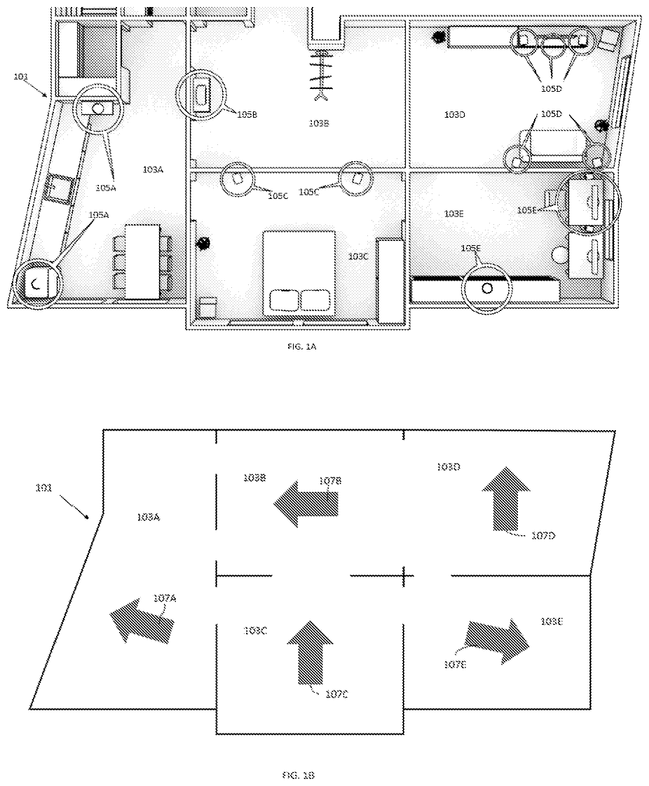

FIGS. 1A to 1C show an example combined space comprising a plurality of spaces;

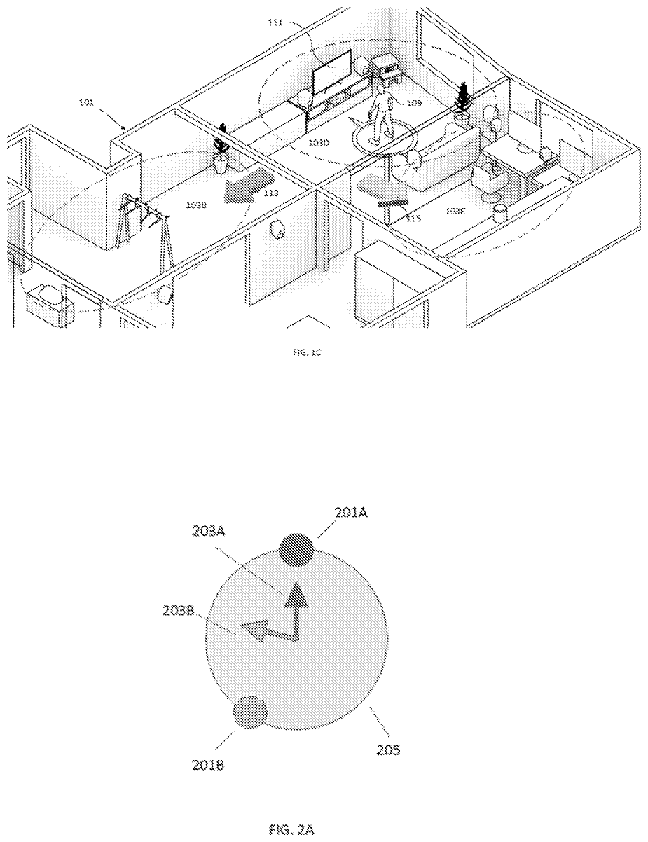

FIGS. 2A to 2C show example spatial audio configurations for different acoustic rendering arrangements and types of spatial audio content;

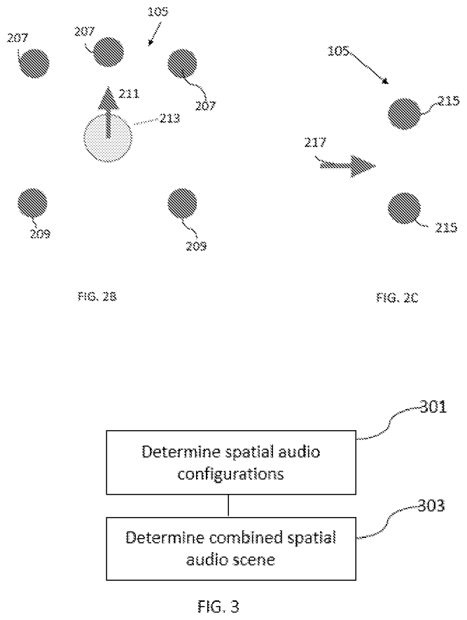

FIG. 3 shows an example method;

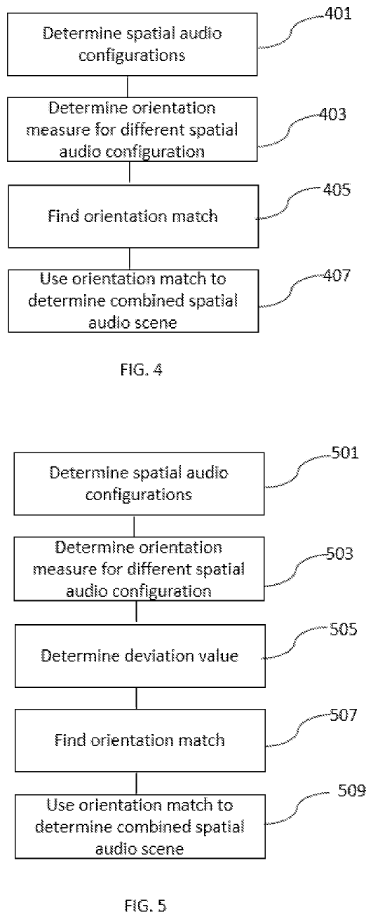

FIG. 4 shows an example method;

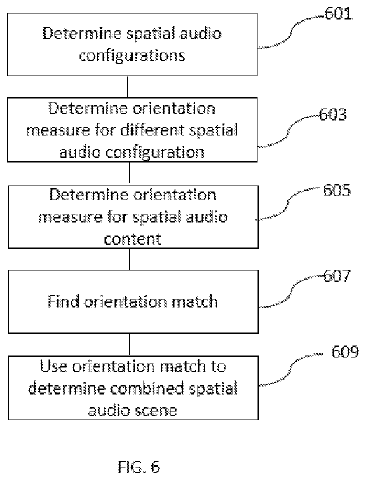

FIG. 5 shows an example method;

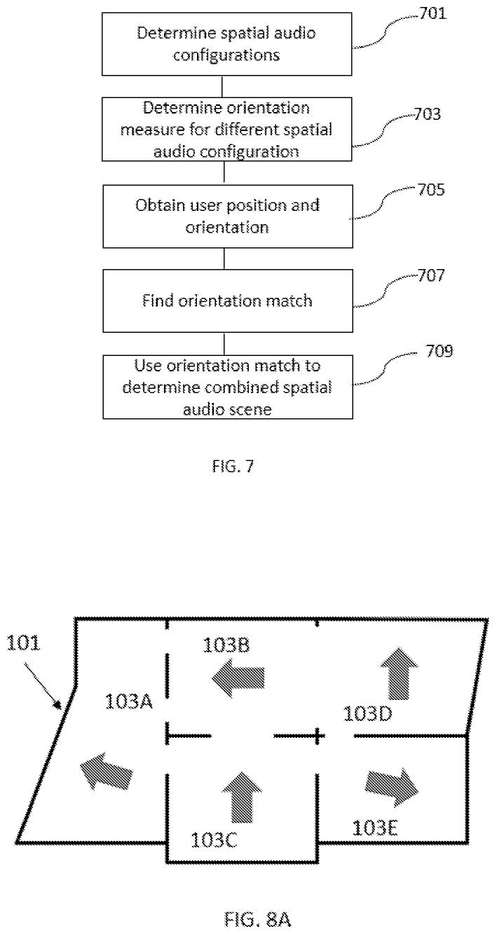

FIG. 6 shows an example method;

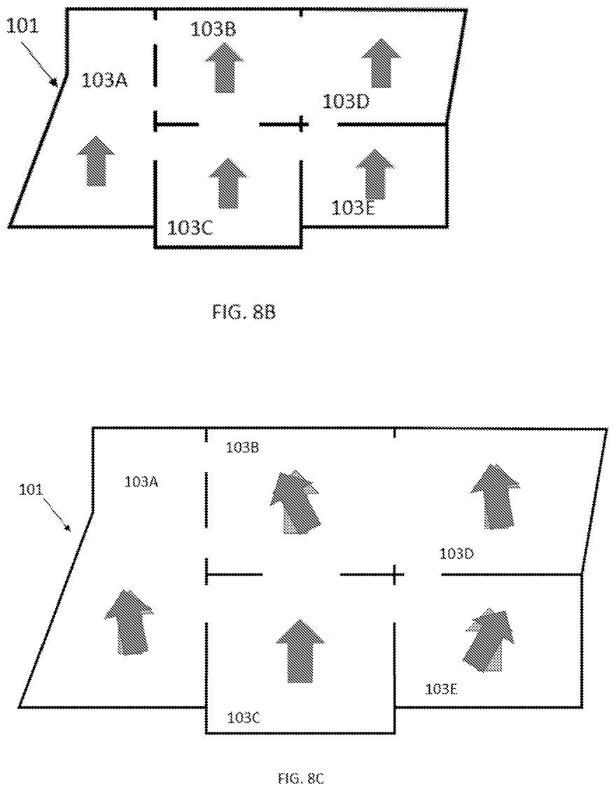

FIG. 7 shows an example method;

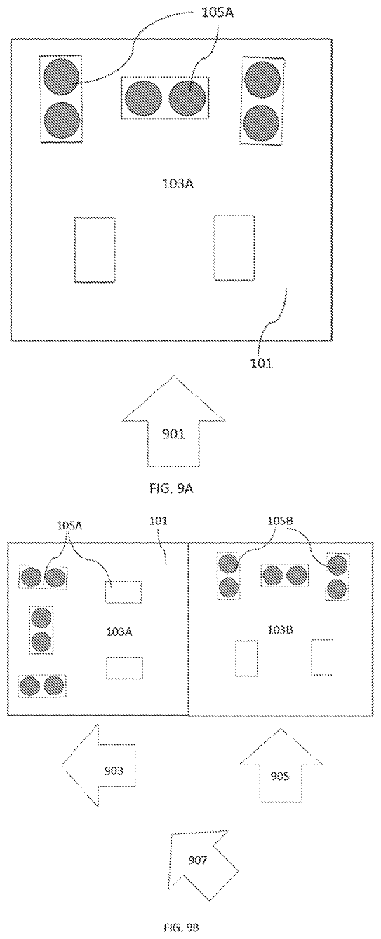

FIGS. 8A to 8C shows example spatial audio scenes;

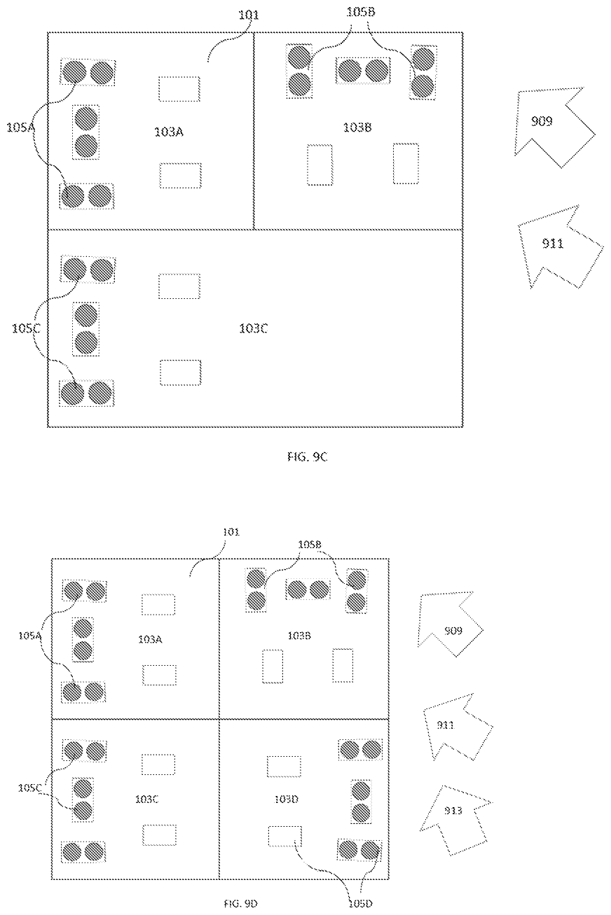

FIGS. 9A to 9E show example combined spatial audio scenes;

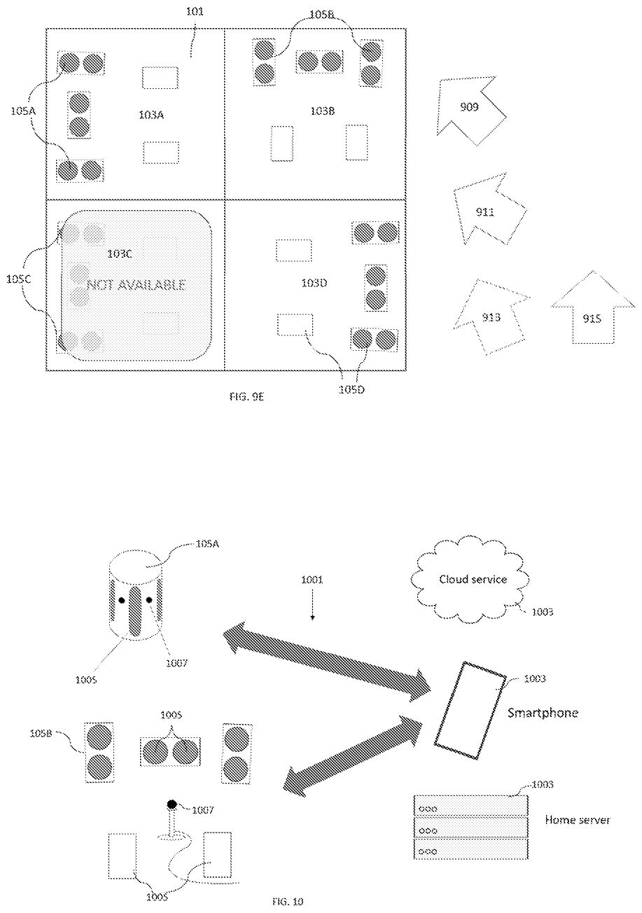

FIG. 10 shows an example system; and

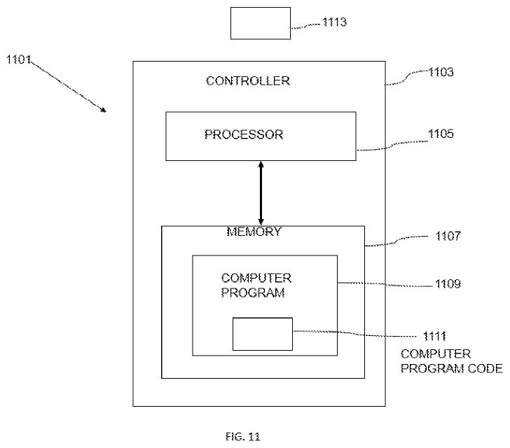

FIG. 11 shows an example apparatus.

### DETAILED DESCRIPTION

Examples of the disclosure relate to apparatus, methods and computer programs for providing spatial audio content using a plurality of different acoustic rendering arrangements. The different acoustic rendering arrangements can be in different parts of a building or other type of area and one or more users can move between the different acoustic rendering arrangements while a spatial audio content is being rendered. For instance, a building such as a home or office could comprise a plurality of different rooms with different acoustic rendering arrangements in the different rooms. A user could be listening to spatial audio content such as a 3GPP spatial voice call or mediated reality content, as they move between rooms. The different acoustic rendering arrangements can lead to a discontinuous spatial audio experience for the user as they move between the different rooms. However, in examples of the disclosure the spatial audio scenes of the different acoustic rendering arrangements can be adjusted to provide for a continuous, or substantially continuous, spatial audio experience for users in the different rooms.

FIGS. 1A to 1C show an example combined space 101 comprising a plurality of spaces 103 that could benefit from the implementation of examples of the disclosure.

FIG. 1A shows a plan view of the combined space 101. In this example the combined space 101 is an apartment that provides a living space for a user. It is to be appreciated that the combined space 101 could be used for other purposes in other examples of the disclosure. For example, the combined space 101 could comprise a work space such as an office or any other suitable type of space.

In the example of FIG. 1A the combined space 101 comprises five different spaces 103. In this example each of the different spaces 103 comprises a different room. In the example of FIG. 1A the combined space comprises a kitchen space 103A, a hallway space 103B, a bedroom space 103C, a living room space 103D and a home office space 103E. Other numbers and types of spaces 103 could be provided in other examples.

Each of the different spaces 103 comprises a different acoustic rendering arrangement 105. Each acoustic rendering arrangement can comprise one or more loudspeakers. Each loudspeaker can comprise one or more transducers. The acoustic rendering arrangements 105 can be configured to playback spatial audio to one or more users within the respective spaces 103. The acoustic rendering arrangements 105 define the number and relative positions of the loudspeakers within the space 103. The acoustic rendering arrangement can also at least partly be determined by characteristics of the space 103 that can affect the acoustic response of the space. For example, it can bet determined by the size and shape of the space and/or any other suitable characteristics.

In the example of FIG. 1 the first acoustic rendering arrangement 105A in the kitchen space 103A comprise two smart speakers, the second acoustic rendering arrangement 105B in the hallway space 105B comprises one smart speaker, the third acoustic rendering arrangement 105C in the bedroom space 13C comprises a stereo system, the fourth acoustic rendering arrangement 105D in the living room space 103D comprises a 5.0 surround sound arrangement and the fifth acoustic rendering arrangement 105E in the home office space 105E comprises a computer audio system (2.0) and a smart speaker. Other acoustic rendering arrangements 105 could be used in other examples of the disclosure.

In some examples the acoustic rendering arrangement 105 can define the spatial audio configuration for a space 103. The spatial audio configuration can provide an indication of the main orientation for a user listening to spatial audio within a space. The main orientation is a direction that a user should face in order to hear an optimal, or substantially optimal, played back spatial audio signal. In some examples the main orientation within a space 103 can be determined by the spatial audio capabilities of the acoustic rendering arrangement within the space 103.

In the example combined space 101 of FIG. 1A the different acoustic rendering arrangements 105 provide for different main orientations in the different spaces 103. This is shown in FIG. 1B. FIG. 1B shows a plan view of the same combined space 101 as shown in FIG. 1A. The arrows 107A-E indicated in FIG. 1B show the main orientation for a user in each of the different spaces 103A-103E.

In FIG. 1B the arrows 107C and 107D are pointing towards the same direction. This shows that the main orientation is the same, or substantially the same, in both the living room space 103D and the bedroom space 103C. In the plan view shown in FIG. 1B these arrows point straight ahead. The arrows 107A and 107B both point towards the left-hand side of the combined space 101. The main orientation is similar, but not exactly the same, for both the kitchen space 103A and the hallway space 103B. The arrow 107E points towards the right-hand side of the combined space 101. This shows that the main orientation is different in the office space 101E to anywhere else in the combined space 101.

FIG. 1B therefore shows that there can be a significant difference in the main orientations for the user in the different spaces 103 due to the different acoustic rendering arrangements 105 that are used. As a user moves between the spaces 103 the switching between the different orientations can lead to a discontinuous spatial audio experience for the user.

FIG. 1C shows a user 109 who could be moving through the combined space 101. The user 109 starts in the living room space 103D. The user 109 is facing towards the television 111 which is the main orientation for the acoustic rendering arrangement 105D in the living room space 103D.

The user 109 could move from the living room space 103D into either the hallway space 103B as indicated by the arrow 113 or the office space 103E as indicated by arrow 115. If the user 109 moves into the hallway space 103B then the acoustic rendering arrangement 105B in the hallway space 103B has a different main orientation to the acoustic rendering arrangement 105D in the living room space 103D.

Similarly, if the user 109 moves from the living room space 105D into the office space 103E as indicated by arrow 115 then the acoustic rendering arrangement 105E in the home office space 103E also has a different main orientation to the acoustic rendering arrangement 105D in the living room space 103D.

The differences in the spatial audio configurations in the different spaces 103 can therefore create a discontinuous spatial audio experience as the user moves between the respective spaces 103. This could be disorientating for the user 109. This could also cause a poor listening experience for the user 109 and/or could require a manual input from the user 109 in order to correct this, for example, by manually changing orientation of a playback when moving between spaces 103.

A similar problem can arise if there are a plurality of users 109 and different users 109 are located within different spaces 103 of the combined space 101. If the spatial audio content is being rendered simultaneously for the users 109 in different spaces 101 this could lead to poor spatial audio experience for any users 109 who aren't aligned with a main orientation.

FIGS. 2A to 2C show different example spatial audio configurations for different acoustic rendering arrangements 105 and types of audio content.

In FIG. 2A shows that the spatial audio configuration for a space can be dependent upon the type of spatial audio content that is being provided and not just on the acoustic rendering arrangement 105. In the example of FIG. 2A the content that is being provided is scene dependent so that the spatial characteristics of the audio content is dependent upon the location of sound sources 201 within the scene. Such content could comprise Metadata assisted spatial audio (MASA), Ambisonics or any other suitable type of spatial audio.

In the example of FIG. 2A the scene comprises two sound sources 201A, 201B provided at different locations. The scene also comprises ambient sounds 205. The ambient sounds 205 can be non-directional so that they are not dependent upon the orientation of a user 109.

In the example of FIG. 2A the arrows 203A, 203B indicate the main directions for a user 109 listening to the spatial audio content. The main directions are the directions that a user 109 should face to hear an optimal, or substantially optimal, played back spatial audio signal. Where the spatial audio content is scene dependent the main directions are dependent upon the position of the sound sources 201A, 201B. In the example of FIG. 2A the first direction 203A is facing towards the first sound source 201A. This can provide the optimal, or substantially optimal, audio quality for the first sound source 201A. The second direction 203B is facing between the first sound source 201A and the second sound source 201B. This can provide optimal, or substantially optimal, audio quality for both the first sound source 201A and the second sound source 201B, when both are present in the scene.

Where the spatial audio content is scene dependent the main directions, and therefore the spatial audio configurations, can change over time. For example, the sound sources 201 within the scene could move and/or different sound sources 201 could create sounds at different times.

FIG. 2B shows an example where the main orientation is determined by the acoustic rendering arrangement 105. In FIG. 2B the example acoustic rendering arrangement 105 is channel-based surround sound acoustic rendering arrangement such as 5.1. For example, professional 5.1 content is typically mixed such that the main orientation is towards the center speaker. Other types of surround sound arrangements could be used in other examples of the disclosure. In the example of FIG. 2B the acoustic rendering arrangement 105 comprises three front channels 207 and two surround channels 209. For this acoustic rendering arrangement 105 the main orientation for the user 109 is facing towards the front channels 207 as indicated by the arrow 211.

The acoustic rendering arrangement 105 shown in FIG. 2B can also provide low frequency effects (LFE) 213. These can be non-directional and so can be independent of the direction that the user 109 is facing.

FIG. 2C shows another example where the main orientation is determined by the acoustic rendering arrangement 105. In FIG. 2C the example acoustic rendering arrangement 105 is a stereo arrangement. In the example of FIG. 2C the acoustic rendering arrangement 105 comprises two channels 215 that are combined spaced apart from each other. For this acoustic rendering arrangement 105 the main orientation for the user 109 is facing into the gap between the two channels 215 as indicated by the arrow 217.

It is to be appreciated that other examples of acoustic rendering arrangements 105 and types of audio content could be used in other examples of the disclosure and these could have different main orientations.

FIG. 3 shows an example method according to examples of the disclosure.

The method comprises, at block 301, determining a plurality of spatial audio configurations. The method can comprise determining at least a first spatial audio configuration for a first space 103 comprising a first acoustic rendering arrangement 105 and determining at least a second spatial audio configuration for a second space 103 comprising a second acoustic rendering arrangement 105. Where more than two spaces 103 are provided within a combined space 101 then the spatial audio configurations can be determined for each of the spaces 103.

The different spaces 103 can comprise different rooms or other areas of a combined space 101. For example, they could comprise different rooms in a home as shown in FIGS. 1A to 1C or different rooms in an office or any other suitable types of spaces 103. It is to be appreciated that the spaces 103 need not be limited to indoor spaces and that in some examples the spaces 103 could comprise one or more outdoor spaces 103.

The spatial audio configurations determine the main orientation of the user 109 within the space 103 at which spatial audio played back by the acoustic rendering arrangements 105 will be optimal or substantially optimal. The spatial audio configuration can also determine the orientations at which the playback of the spatial audio quality would be above a quality threshold and/or the orientations at which the playback of the spatial audio quality would be below a quality threshold.

The spatial audio configurations can be determined based on acoustic rendering arrangements 105. In such examples the spatial audio configurations can be determined based on the number of loudspeakers within the acoustic rendering arrangement 105, the relative positions of the loudspeakers within the acoustic rendering arrangement 105, the type of loudspeakers within the acoustic rendering arrangement 105 and/or any other suitable parameters of the acoustic rendering arrangement 105.

In some examples the spatial audio configurations can be determined based on the type of spatial audio content that is being played back. For example, if the spatial audio content is scene dependent then the main orientation can be determined by the position of one or more sound sources 201 within the audio scenes.

Information relating to the different spatial audio configurations can be obtained using any suitable means. For example, it can be collected by a user device or a server device or by any other suitable type of device that can be coupled to the acoustic rendering arrangement 105. Information relating to the different spatial audio configurations for the different spaces 103 can be stored in a memory and retrieved as needed.

In some examples, information relating to the spatial audio configurations can be updated when appropriate. For example, a user 109 could move one or more of the loudspeakers within a acoustic rendering arrangement 105 or could change the number and/or types of loudspeakers that are used. In such examples the change in the acoustic rendering arrangement 105 could be detected and the stored information relating to the spatial audio configurations can be updated as needed.

At block 303 the method comprises determining a combined spatial audio scene for an area 101 comprising at least the first space 101 and the second space 101. The combined spatial audio scene is based on, at least, the first spatial audio configuration and the second spatial audio configuration. The combined spatial audio scene can provide an indication of a new main orientation that is to be used for all of the combined space 101 and/or can provide a change to the main orientation for some of the spaces 103. This combined spatial audio scene can adjust the direction that a user 109 should face to obtain the optimal, or substantially optimal, spatial audio experience in one or more of the spaces 103.

The combined spatial audio scenes are configured to reduce changes between the main orientation for a user 109 in the first space 103 and a user 109 in the second space 103. In some examples the combined spatial audio scenes can be configured to minimise, or substantially minimise, changes between the main orientation for a user 109 in the first space 103 and a user 109 in the second space 103. This can provide a more continuous spatial audio experience for the user 109 as they move between the different spaces 103 while the different acoustic rendering arrangements 105 are being used to playback the spatial audio.

In some examples the combined spatial audio scenes can require the same main orientation to be used for all of the spaces 103. In other examples different main orientations can be used in different spaces 103 but the combined spatial audio scenes can limit the variation in the respective main orientations.

In some examples the method can also comprise enabling playback of spatial audio signals using the combined audio settings in at least the first space 103 and the second space 103. In some examples the spatial audio can be played back simultaneously in both the first space 103 and the second space 103 using the combined settings in both the first space 103 and the second space 103. In some examples the spatial audio can be played in different spaces 103 at different times as one or more users 109 move between the different spaces 103.

The combined spatial audio scenes can be implemented by adjusting one or more spatial characteristics of the spatial audio that is to be played back by the acoustic rendering arrangements 105 so that the spatial audio is aligned with the main orientations required by the combined spatial audio scenes.

The combined spatial audio scenes therefore reduce changes in a main orientation between different spaces 103. This reduction provides a substantially continuous spatial audio experience for a user 103 moving between the different spaces 103 and so maintains spatial audio continuity in response to a user position changing from a first space 103 to a second space. In other examples the spatial continuity could be maintained by maintaining spatial audio source direction accuracy, maintaining spatial audio energy balance between directions or by any other suitable means.

FIGS. 4 to 7 show more detailed methods of determining the combined spatial audio scene.

FIG. 4 shows an example method that uses orientation measures to determine the combined spatial audio scene.

At block 401 the method comprises determining a plurality of spatial audio configurations for a plurality of different acoustic rendering arrangements 105 in a plurality of different spaces 103. The different spaces 103 can be within the same combined space 101, for example they can all be within the same building. For instance, it can be determined that a first space 103 has a surround sound acoustic rendering arrangement 105 while a second space 103 has a smart speaker-based acoustic rendering arrangement 105 and other types of acoustic rendering arrangement 105 can be used in other spaces 103.

At block 403 at least one orientation measure is determined for each spatial audio configuration. The orientation measure relates to the quality of spatial audio play back for different angles of the spatial audio configuration.

The orientation measures can provide an indication of spatial audio quality at different user orientations within the different spaces 109. For example, this can provide a measure of the spatial audio quality at a plurality of different angles relative to the main orientation or any other suitable reference. The spatial audio quality can be measured at a plurality of different angular intervals.

Any suitable means can be used to measure the spatial audio quality at the different angular intervals. In some examples the spatial audio quality can be measured by comparing the audio signal at reference directions, such as the main orientation, with audio signals that would be obtained at the different angles. The audio signal that is used to obtain the orientation measures can comprise a test signal that can comprise predetermined spatial characteristics, the spatial audio content that is to be played back or any other suitable spatial audio signal.

As an example, an orientation measure Qₛ(m), is obtained for each of the spatial audio configurations of the spaces s where m is based on a measure interval m can be any suitable angular interval.

In examples where the space 103 comprises a 5.1 surround sound acoustic rendering arrangement 105 the main orientation can be taken to be a direction facing towards the C channel loudspeaker. The orientation measures Qₛ(m) can be obtained at discrete angular intervals for azimuthal rotation. The discrete values could be 5° intervals or any other suitable value. In some examples the orientation measures can be obtained for a whole 360° azimuthal rotation. In other examples the orientation measures Qₛ(m) could be obtained for a smaller range of angles.

In some examples, different orientation measures Qₛ(m) could be obtained for different types of audio content. For example, the same acoustic rendering arrangement 105 could have different spatial audio configurations for different types of audio content. Different orientation measures Qₛ(m) could be obtained based on whether the audio content is associated with corresponding video content or 3GPP spatial voice calls or mediated reality content or any other suitable type of content.

The orientation measures Qₛ(m) can be obtained by using an audio test signal. The test signal could comprise the current audio content that is being played back or could comprise a specific test signal such as a noise sequence, an impulse, or any other suitable test signal. The orientation measures Qₛ(m) can be obtained by using the acoustic rendering arrangement 105 in the space 103 to play back the test signal and capturing the played back signals by a plurality of microphones within the space 103. The captured microphone signals can be compared for the different angular intervals to obtain the orientation measures Qₛ(m).

In some examples the orientation measures Qₛ(m) can provide an indication of the main orientation for the user for each of the acoustic rendering arrangements. In some examples the orientation measures Qₛ(m) can provide an indication of a range of orientations at which the spatial audio quality is above a given threshold.

At block 405 the method comprises finding an orientation match between the different spatial audio configurations in the different spaces 103. In some examples the orientation match can be a best match or a substantially best match. The orientation match can be found by minimising, or substantially minimising the total change in orientation across all of the different spatial audio configurations in the different spaces 103. The minimising, or substantially minimising the total change in orientation across all of the different spatial audio configurations in the different spaces 103 can maximise, or substantially maximise the overall spatial playback quality for users in different spaces 103.

At block 407 the combined spatial audio scene can be determined using the orientation match. In this example the combined spatial audio scene can be the use of the same orientation in each of the different spaces 103. The spatial audio can be processed to adjust the spatial characteristics of the audio so as to enable the same orientation to be used for spatial audio playback by the acoustic rendering arrangements 105 in each of the spaces 103.

In some examples the combined audio setting can be determined by applying different weightings to different spaces 103 within the combined space 101 covered by the combined audio settings. For instance, spaces 103 that a user 109 is more likely to be in can be assigned a higher weighting than spaces that a user is less likely to be in. In the example shown in FIGS. 1A to 1C it can be determined that a user 109 spends most of their time in the living room space 103D. In this case the living room space 103D can be assigned a higher priority than the other spaces 103A, 103B, 103C, 103E when the combined weighting is being determined.

The example method shown in FIG. 4 enables the same main orientation to be used in each of the different space 103. This can provide for a consistent experience for the user 109 as the user 109 moves between the different spaces 103. In this example method there is a trade-off between the consistency of the spatial presentation of the audio content and the quality with which it can be played back. Although the example method of FIG. 4 provides a common orientation for the different spaces 103 the orientation could be sub-optimal, or could fall below some threshold quality value, for some sub-spaces 103.

FIG. 5 shows another example method that can be used to implement examples of the disclosure. This example is similar to the method shown in FIG. 4 however in the example method of FIG. 5 adjustments can be made to provide higher spatial audio quality levels while maintaining consistency of the spatial presentation of the audio content.

At block 501 the method comprises determining a plurality of spatial audio configurations for a plurality of different acoustic rendering arrangements 105 in a plurality of different spaces 103. This can be as described in relation to FIG. 4 or could use any other suitable process.

At block 503 at least one orientation measure is determined for each spatial audio configuration. The orientation measure relates to the quality of spatial audio play back for different angles of the spatial audio configuration. The orientation measures could be obtained using the methods described in relation to FIG. 4 or could use any other suitable process.

At block 505 deviation values are determined. The deviation values provide an indication of an allowed difference in spatial audio scenes between a first space 103 and a second space 103. In some examples the deviation values can be determined for each pair of spaces 103 within the combined space 101. In some examples the deviation values might only be obtained for a subset of the pairs of spaces.

The deviation values can provide an indication of an allowed difference in spatial audio scenes between the first space and the second space. In some examples the deviation values can provide an indication of the differences in the main orientation that can be accepted as a user 109 moves between different spaces 101. This provides an indication of the variation in main orientations that would still allow for a continuous, or substantially continuous, spatial audio experience for a user 109 moving between the spaces 103.

In some examples the deviation values can be determined by acoustic rendering arrangements 105 or the audio content provider or by any other suitable means. In some examples the deviation values can be set by a manual input. For instance, a user 109 could manually limit a deviation value to between 0 and 45°, or to be within any other suitable range.

At block 507 the method comprises finding an orientation match between the different spatial audio configurations in the different spaces 103. The orientation match can be found by minimising, or substantially minimising the total change in orientation across all of the different spatial audio configurations in the different spaces 103 while taking into account any limitations imposed by the deviation values. The deviation values can allow neighbouring spaces 103 to have an orientation that differs by an angular value that is limited by the deviation value.

At block 509 the combined spatial audio scene can be determined using the orientation match. In this example the combined spatial audio scene can use different main orientations in the different spaces 103 provided that the change in orientation between neighbouring spaces 103 does not exceed a threshold value. This can provide for a consistent experience for the user 109 as the user 109 moves between the different spaces 103 and can also provide for improved spatial audio quality compared to the method shown in FIG. 4.

FIG. 6 shows another example method. The example methods shown in FIGS. 4 and 5 do not take into account the format of the content that is to be played back. FIG. 6 shows an example method in which this is taken into account.

At block 601 the method comprises determining a plurality of spatial audio configurations for a plurality of different acoustic rendering arrangements 105 in a plurality of different spaces 103. This can be as described in relation to FIGS. 4 and 5 or could use any other suitable process.

At block 603 at least one orientation measure is determined for each spatial audio configuration. The orientation measure relates to the quality of spatial audio play back for different angles of the spatial audio configuration. The orientation measures could be obtained using the methods described in relation to FIG. 4 or could use any other suitable process.

At block 605 orientation measures for the type of spatial audio content are determined. The content orientation measures can be determined for the type of spatial audio content that is to be played back using the acoustic rendering arrangements 105. The spatial audio content can be scene-dependent audio content such that the main orientation is dependent upon the location of one or more sound sources 201 within a scene. The spatial audio content could be MASA, Ambisonics or any other suitable type of spatial audio content. In some examples a plurality of different orientation measures for different types of spatial audio content can be determined.

The content orientation measure can provide an indication of the main orientation for the spatial audio content. In some examples the content orientation measure can provide an indication of a plurality of important orientations for the spatial audio content. These can be orientations that provide spatial audio quality above a given threshold.

In examples where a plurality of important directions are determined different weightings can be assigned to the different orientations. The different weightings can be based on a level of importance of the orientations. The importance of the orientations can be based on the relative positions of the sound sources, the types of sound sources, a metadata that accompanies the content, or any other suitable parameter.

The content orientation measures can change over time. For instance, as sound sources 201 move within a sound scene or as different sound sources 201 start and/or stop generating sound the main orientations and other important orientations can change. This can change the angular position of the respective orientations and/or the level of importance assigned to the respective orientations. This would then lead to changes in the content orientation measures.

Other factors can also be used to determine a content orientation measure. For instance, in some examples the content orientation measure can be determined by a signalled property such as the intended reproduction orientation of an audio scene. These properties could be signalled with the spatial audio content.

At block 607 the method comprises finding an orientation match between the different spatial audio configurations in the different spaces 103. The orientation match can be found by minimising, or substantially minimising the total change in orientation across all of the different spatial audio configurations in the different spaces 103 while taking into account the different orientation measures and the different content orientation measures.

At block 609 the combined spatial audio scene can be determined using the orientation match. The combined spatial audio scene can cause the same main orientation to be used in each of the spaces 103. In other examples the combined spatial audio scene can enable different main orientations to be used in different spaces. In such examples the method of FIG. 5 can be combined with the method of FIG. 6, or any other suitable method, to limit the deviations in the different orientations that are used.

Any suitable methods or algorithms can be used to find the content orientation measures and the main orientations or other important orientations for the spatial audio content. The following algorithm could be used in some examples. This example algorithm relates to metadata-assisted spatial audio (MASA) format audio, although it could be used with any other suitable type of spatial audio content. In some examples spatial audio content could be converted into a MASA format to enable the following algorithm to be used.

The input comprises spatial audio signals in frequency domain S(i, b, n), where i is the channel index, b is the frequency bin, and n is the temporal frame. Spatial metadata corresponding to the spatial audio signals is also obtained. The spatial metadata comprises at least a direction (θ(k,n), ϕ(k,n)) (azimuth, elevation) and a direct-to-total energy ratio r(k,n), where k is the frequency band. In some implementations, the fit can be reduced to horizontal plane only. This can be appropriate for examples of the disclosure which can be implemented using acoustic rendering arrangements and so changes in elevation are not always needed or are generally of lesser importance for user's percept. In this example the directions have been considered in all three dimensions for the sake of completeness.

The energies are estimated using

$$E ( k , n ) = {\sum }_{i} {\sum }_{{b}_{k , low}}^{{b}_{k , high}} {\vert S ( i , b , n ) \vert}^{2}$$

where b_{k,low} is the lowest bin of the band k and b_{k,high} is the highest bin. The frequency bands in the energy estimation should match the frequency bands of the input spatial metadata.

Then, the direction (θ(k, n), ϕ(k, n)) is converted to a Cartesian coordinate vector weighted by the energy E(k, n) and the direct-to-total energy ratio r(k, n)

x(k,n)=E(k,n)r(k,n)cos θ(k,n)cos ϕ(k,n)

y(k,n)=E(k,n)r(k,n)sin θ(k,n)cos ϕ(k,n)

z(k,n)=E(k,n)r(k,n)sin ϕ(k,n)

v(k,n)=[x(k,n),y(k,n),z(k,n)]^{T}

These vectors are summed over a suitable frequency range and time period. In this example, the frequency range is the whole audio spectrum (that is, all the frequency bands from 0 to K−1), but in some implementations the estimation can be done in smaller frequency ranges. The time period is in this example from N₁ to N₂, resulting in the following equation

$${v}_{N 12}^{′} = {\sum }_{{N}_{1}}^{{N}_{2}} {\sum }_{k = 0}^{K - 1} v ( k , n )$$

The energies are summed over the same period

$${E}_{N 12} = {\sum }_{{N}_{1}}^{{N}_{2}} {\sum }_{k = 0}^{K - 1} E ( k , n )$$

Using the two equations above, a spatial average vector, used here to describe the spatial scene main orientation in a current time interval, is computed as

$${v}_{N 12} = \frac{{v}_{N 12}^{′}}{{E}_{N 12}}$$

This same procedure can be performed on further time intervals, e.g., from Nₜ₋₁ to Nₜ, resulting in further spatial average vectors V_{Nt-1, t}.

In order to smooth the change over time, a suitable long-term average updating can be performed. The updating can be performed after each time interval or each audio frame (where the time interval may also correspond to an audio frame, for example, 20 ms) by

V_{LTnew}=(1−β)V_{LTprev}+βV_{Nt-1,1}

where ‘LT’ refers to long-term and β is a suitable update factor such as, for example, β=0.02.

In some examples, the update factor β can be signal-energy dependent. In some further examples, the update factor β can be given by an external input which allows for control of the speed of the update.

FIG. 7 shows another example method. In this example the position of one or more users 109 within the spaces can be taken into account.

At block 701 the method comprises determining a plurality of spatial audio configurations for a plurality of different acoustic rendering arrangements 105 in a plurality of different spaces 103. This can be as described in relation to FIGS. 4 to 6 or could use any other suitable process.

At block 703 at least one orientation measure is determined for each spatial audio configuration. The orientation measure relates to the quality of spatial audio play back for different angles of the spatial audio configuration. The orientation measures could be obtained using the methods described in relation to FIGS. 4 and 6 or could use any other suitable process.

At block 705 information indicating the position and orientation of one or more users 109 within the spaces 103 is obtained. The information indicating the position and orientation of the users 109 can be obtained from tracking data relating to one or more users. The tracking data can be obtained from any suitable positioning systems. The tracking data can provide information indicative of the location of a user 109 within a space 103 and/or the orientation of the user 109 within the space 103. This can provide more detailed information than just an indication of which space 103 the user 109 is located within. The tracking data can also be used to obtain information about updates of the position and/or orientation of the user 109.

At block 707 the method comprises finding an orientation match between the different spatial audio configurations in the different spaces 103. The orientation match can be found by minimising, or substantially minimising the total change in orientation across all of the different spatial audio configurations in the different spaces 103 while taking into account the different orientation measures and the current orientation and/or position of the users 109 within the spaces 103.

In some examples a weighting could be applied to the orientation measures based on the position and/or orientation of the user 103. For instance, if a user 109 is in a first space 103 and is facing towards a second space 103 but away from a third space 103 it can be inferred that the user 103 is moving towards the second space 103. In this case the second space 103 could be given a higher weighting than the third space 103 when the orientation match is being found.

In some examples content orientation measures, such as those described in FIG. 7, could also be used to help to find the orientation match.

At block 709 the combined spatial audio scene can be determined using the orientation match. The combined spatial audio scene can cause the same main orientation to be used in each of the spaces 103. In other examples the combined spatial audio scene can enable different main orientations to be used in different spaces. In such examples the method of FIG. 5 can be combined with the method of FIG. 6, or any other suitable method, to limit the deviations in the different orientations that are used.

In the method shown in FIG. 7 the tracking data can be obtained for one or more users 109 within the combined space 101. In examples where there are a plurality of users 109 the combined audio settings can be determined based on the tracking data for the plurality of different users 109. Different weightings can be applied to the different users 109 so that some users can influence the combined audio settings more than others. The weightings applied to the different users 109 can be applied based on the position of the user 109, whether or not the user 109 is moving and/or any other suitable factor.

FIGS. 8A to 8C shows example main orientations for different spaces 103 in different examples of the disclosure.

FIGS. 8A to 8C show the example combined space 101 of FIGS. 1A to 1C. The combined space 101 comprises five different spaces 105A to 105E as described above. The arrows in the spaces 103 indicate the main orientation for each of the spaces 103 in the respective examples.

FIG. 8A shows the main orientations that are used when examples of the disclosure are not applied. In this example a different main orientation can be used for each of the spaces 103. In this example the main orientation that is used is based on the acoustic rendering arrangement 105 that is used in the space 103. In other examples the main orientation could also be based on the spatial audio content that is being rendered.

FIG. 8B shows the main orientations that are used when the method of FIG. 4 is applied. This method finds a single orientation that can be used for all of the spaces 103A to 103E. This provides for spatial consistency across the area 101 but could result in lower spatial audio quality in some of the spaces 103. For example, there is a 90° angular deviation between the main orientation used in the hallway space 103B in FIG. 8A and the main orientation used in the hall way space 103B in FIG. 8B. Similarly there is an angular deviation larger than 90° between the main orientation used in the office space 103E in FIG. 8A and the main orientation used in the office space 103D in FIG. 8B. These changes in main orientations could reduce the quality of the spatial audio being played back.

FIG. 8C shows the main orientations that could be used when the methods of any of FIG. 5 to 7 are applied. These methods allow for different main orientations to be used in different spaces 103A to 103E but restricts the angular deviation in neighboring spaces 103A to 103E. This provides spatial consistency across the area 101 and also provides spatial audio quality that is above a given threshold.

As shown in FIG. 8C there are some deviations between the main orientations used in the spaces 103 so that the main orientations in neighboring spaces 103 is not exactly the same. However, the angular deviation between the main orientations in neighboring spaces 103 are smaller than those shown in FIG. 8A and so this provides for improved continuity of the spatial audio.

FIGS. 9A to 9E shows example combined spatial audio scenes for different example combined spaces 101.

FIG. 9A shows an example space 103A comprising an acoustic rendering arrangement 105A. In this example the acoustic rendering arrangement 105A comprises a 5.0 acoustic rendering arrangement. Other types of acoustic rendering arrangement 105A could be used in other examples of the disclosure.

The arrow 901 indicates the main orientation for the acoustic rendering arrangement 105A and the space 103A shown in FIG. 9A. In this case the main orientation is facing towards the front channels of the acoustic rendering arrangement 105A.

FIG. 9B shows a plan view of example area 101 comprising a first space 103A and a second space 103B. The first space 103A and the second space 103B can be configured so that a user 109 can move between the spaces 103A, 103B.

Both the first space 103A and the second space 103B comprise a 5.0 acoustic rendering arrangement 105A, 105B. This can enable spatial audio content to be played back for a user 109 when the user 109 is in either of the spaces 103A, 103B and also as a user moves between the spaces 103A, 103B.

The first 5.0 acoustic rendering arrangement 105A in the first space 103A is positioned in a different orientation to the second 5.0 acoustic rendering arrangement 105B. The first 5.0 acoustic rendering arrangement 105A in the first space is rotated through 90° compared to the second 5.0 acoustic rendering arrangement 105B. This results in different main orientations being provided in the different spaces 103A, 103B.

The arrow 903 indicates the main orientation for the first acoustic rendering arrangement 105A in the first space 103A. In this case the main orientation is facing towards the left-hand side of the plan view. The arrow 905 indicates the main orientation for the second acoustic rendering arrangement 105B in the second space 103B. This is directed towards the top of the plan view.

The arrow 907 indicates a combined main orientation that can be provided in a combined audio setting in accordance with examples of the disclosure. In this example the spaces 103A and 103B are given equal weighting and so the combined main orientation is provided at an angle that is midway between the main orientation for the first space 103A and the main orientation for the second space 103B.

FIG. 9C shows a plan view of another example area 101 comprising a first space 103A, a second space 103B and a third space 103C. The spaces 103A, 103B, 103C can be configured so that a user 109 can move between the spaces 103A, 103B, 103C.

Each of the spaces 103A, 103B, 103C comprise a 5.0 acoustic rendering arrangement 105A, 105B, 105C. This can enable spatial audio content to be played back for a user 109 when the user 109 is in any of the spaces 103A, 103B, 103C and also as a user moves between the spaces 103A, 103B, 103C.

The first space 103A and the second space 103B can be as shown in FIG. 9B and described above. The third space 103C also comprises a 5.0 acoustic rendering arrangement 105C. This 5.0 acoustic rendering arrangement 105C is positioned so that it is facing in the same orientation as the first 5.0 acoustic rendering arrangement 105A.

The arrow 909 indicates the combined main orientation that can be provided for an area 101 comprising the first space 103A and the second space 103B. The arrow 911 indicates the combined main orientation that can be provided for an area 101 comprising the first space 103A and the second space 103B and also the third space 103C. As the third acoustic rendering arrangement 105C is facing in the same direction as the first acoustic rendering arrangement 105A this provides a combined main orientation that is directed more towards the left-hand side of the plan view of the area 101.

FIG. 9D shows a plan view of another example area 101 comprising a first space 103A, a second space 103B, a third space 103C and also a fourth space 103D. The spaces 103A, 103B, 103C, 103D can be configured so that a user 109 can move between the spaces 103A, 103B, 103C, 103D.

Each of the spaces 103A, 103B, 103C, 103D comprise a 5.0 acoustic rendering arrangement 105. This can enable spatial audio content to be played back for a user 109 when the user 109 is in any of the spaces 103A, 103B, 103C, 103D and also as a user moves between the spaces 103A, 103B, 103C, 103D.

The first space 103A and the second space 103B can be as shown in FIG. 9B and described above. The third space 103C also comprises a 5.0 acoustic rendering arrangement 105C that is positioned so that it is facing in the same orientation as the first 5.0 acoustic rendering arrangement 105A. The fourth space 103D also comprises a 5.0 acoustic rendering arrangement 105D that is positioned so that it is facing in the opposite orientation as the first 5.0 acoustic rendering arrangement 105A.

The arrow 909 indicates the combined main orientation that can be provided for an area 101 comprising the first space 103A and the second space 103B. This is the same as shown in FIG. 9C. The arrow 911 indicates the combined main orientation that can be provided for an area 101 comprising the first space 103A and the second space 103B and also the third space 103C. This is also the same as shown in FIG. 9C.

The arrow 913 indicates the combined main orientation that can be provided for an area 101 comprising the first space 103A, the second space 103B, the third space 103C and also the fourth space 103D. The main orientation can be provided at an angle that is between the angles indicated by the arrows 909 and 911. The angle of the combined main orientation can be dependent upon different weightings that can be applied to the different spaces 103A, 103B, 103C 103D and/or the different acoustic rendering arrangements 105A, 105B, 105C, 105D.

FIG. 9E shows a plan view of another example area 101 comprising a first space 103A, a second space 103B, a third space 103C and also a fourth space 103D. These can be arranged as shown in FIG. 9D. The spaces 103A, 103B, 103C, 103D can be configured so that a user 109 can move between the spaces 103A, 103B, and 103D but not into the third space 103C. For example, another user could be using the third space 103C and this could prevent other users from accessing this combined space.

The arrow 909 indicates the combined main orientation that can be provided for an area 101 comprising the first space 103A and the second space 103B. This is the same as shown in FIGS. 9C and 9D. The arrow 911 indicates the combined main orientation that can be provided for an area 101 comprising the first space 103A and the second space 103B and also the third space 103C. This is also the same as shown in FIGS. 9C and 9D.

The arrow 913 indicates the combined main orientation that would be provided for an area 101 comprising the first space 103A, the second space 103B, the third space 103C and also the fourth space 103D. However, as the third space 103C is not available this space 103C can be removed from the calculations when the combined audio settings are being determined and/or ca be provided with a lower weighting. This causes the dynamic adjustment of the combined main orientation so that the main orientation for the combined audio setting is now facing upwards as indicated by the arrow 915.

It is to be appreciated that variations can be made to the examples described herein. For instance, in some examples a user 109 can make an input to override the combined audio settings. For instance, if the user is watching a film on the television 111 in the living room space 103D they might wish the main orientation for this space 103D to be fixed and not changed if they were to leave the space 103D temporarily or there were other users 109 in other spaces 103. The user 109 could then enable the combined audio settings to be used when the user 109 is listening to a different type of audio content such as 3GPP spatial voice calls.

FIG. 10 shows an example system 1001 that could be used to implement examples of the disclosure. The system 1001 comprises a plurality of acoustic rendering arrangements 105 and one or more system devices 1003.

In the example system 1001 shown in FIG. 10 the system 1001 comprises two acoustic rendering arrangements 105. It is to be appreciated that any number of acoustic rendering arrangements 105 could be used in other examples of the disclosure.

Each of the acoustic rendering arrangements 105 is provided within a different space 103 of a combined space 101. Each of the acoustic rendering arrangements 105 can be configured to playback spatial audio to a user 109 when the user 109 is in the space 103.

In the example system 1001 of FIG. 10 the first acoustic rendering arrangement 105A comprises one or more smart speakers and the second acoustic rendering arrangement 105B comprises a 5.0 acoustic rendering arrangement. Other types of acoustic rendering arrangement 105 can be used in other examples of the disclosures.

The smart speaker comprises a plurality of loudspeaker elements 1005 that are spatially distributed within the smart speaker so as to enable the playback of spatial audio. The 5.0 acoustic rendering arrangement also comprises a plurality of loudspeaker elements 1005. In the 5.0 acoustic rendering arrangement the loudspeaker elements can be positioned in different locations within the space 103.

In the example of FIG. 10 each of the acoustic rendering arrangements 105 also comprise a microphone 1007. The microphone can be configured to enable spatial audio quality to be measured. This can enable orientation measures, or any other suitable parameters, to be determined for the acoustic rendering arrangements 105.

The system devices 1003 can comprise any devices that can be configured to control the system 1001. The system devices 1003 can be configured to obtain spatial audio content and control the acoustic rendering arrangements 105 to playback the spatial audio content. The system devices 1003 can be configured to apply the methods disclosed herein to provide combined audio settings for the plurality of different acoustic rendering arrangements 105. In some examples the system devices 1003 can be configured to adjust one or more spatial characteristics of the spatial audio to take the combined audio settings into account.

As shown in FIG. 10 the system devices 1003 can be a user device such as a smartphone, a home server, a cloud service or any other suitable type of device or combinations of devices.

The system devices 1003 are configured to communicate with the acoustic rendering arrangements 105 via any suitable communications means. The communication means can comprise wired and/or wireless connections.

FIG. 11 shows an example apparatus 1101 that could be used to implement examples of the disclosure. The apparatus 1101 illustrated in FIG. 11 can be a chip or a chip-set. The apparatus 1101 can be provided within a system device 1003 as shown in FIG. 10 or could be provided within any other suitable devices or systems.

In the example of FIG. 11 the apparatus 1101 comprises a controller 1103. In the example of FIG. 11 the implementation of the controller 1103 can be as controller circuitry. In some examples the controller 1103 can be implemented in hardware alone, have certain aspects in software including firmware alone or can be a combination of hardware and software (including firmware).

As illustrated in FIG. 11 the controller 1103 can be implemented using instructions that enable hardware functionality, for example, by using executable instructions of a computer program 1109 in a general-purpose or special-purpose processor 1105 that can be stored on a computer readable storage medium (disk, memory etc.) to be executed by such a processor 1105.

The processor 1105 is configured to read from and write to the memory 1107. The processor 1105 can also comprise an output interface via which data and/or commands are output by the processor 1105 and an input interface via which data and/or commands are input to the processor 1105.

The memory 1107 is configured to store a computer program 1109 comprising computer program instructions (computer program code 1111) that controls the operation of the apparatus 1101 when loaded into the processor 1105. The computer program instructions, of the computer program 1109, provide the logic and routines that enables the apparatus 1101 to perform the methods illustrated in FIGS. 3 to 7. The processor 1105 by reading the memory 1107 is able to load and execute the computer program 1109.

The apparatus 1101 therefore comprises: at least one processor 1105; and at least one memory 1107 including computer program code 1111, the at least one memory 1107 and the computer program code 1111 configured to, with the at least one processor 1105, cause the apparatus 1101 at least to perform:
determining a first spatial audio configuration for at least a first space comprising a first acoustic rendering arrangement and determining a second spatial audio configuration for at least a second space comprising a second acoustic rendering arrangement; and
determining a combined spatial audio scene for a combined space comprising at least the first space and the second space wherein the combined spatial audio scene is based on the first spatial audio configuration and the second spatial audio configuration and wherein the combined spatial audio scene is configured to maintain spatial audio continuity in response to a user position changing from the first space to the second space.

As illustrated in FIG. 11 the computer program 1109 can arrive at the apparatus 1101 via any suitable delivery mechanism 1113. The delivery mechanism 1113 can be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 1109. The delivery mechanism can be a signal configured to reliably transfer the computer program 1109. The apparatus 1101 can propagate or transmit the computer program 1109 as a computer data signal. In some examples the computer program 1109 can be transmitted to the apparatus 1101 using a wireless protocol such as Bluetooth, Bluetooth Low Energy, Bluetooth Smart, 6LoWPan (IPv6 over low power personal area networks) ZigBee, ANT+, near field communication (NFC), Radio frequency identification, wireless local area network (wireless LAN) or any other suitable protocol.

The computer program 109 comprises computer program instructions for causing an apparatus 1101 to perform at least the following:
determining a first spatial audio configuration for at least a first space comprising a first acoustic rendering arrangement and determining a second spatial audio configuration for at least a second space comprising a second acoustic rendering arrangement; and
determining a combined spatial audio scene for a combined space comprising at least the first space and the second space wherein the combined spatial audio scene is based on the first spatial audio configuration and the second spatial audio configuration and wherein the combined spatial audio scene is configured to maintain spatial audio continuity in response to a user position changing from the first space to the second space.

The computer program instructions can be comprised in a computer program 1109, a non-transitory computer readable medium, a computer program product, a machine readable medium. In some but not necessarily all examples, the computer program instructions can be distributed over more than one computer program 1109.

Although the memory 1107 is illustrated as a single component/circuitry it can be implemented as one or more separate components/circuitry some or all of which can be integrated/removable and/or can provide permanent/semi-permanent/dynamic/cached storage.

Although the processor 1105 is illustrated as a single component/circuitry it can be implemented as one or more separate components/circuitry some or all of which can be integrated/removable. The processor 1105 can be a single core or multi-core processor.

References to “computer-readable storage medium”, “computer program product”, “tangibly embodied computer program” etc. or a “controller”, “computer”, “processor” etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” can refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software might not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the FIGS. 3 to 7 can represent steps in a method and/or sections of code in the computer program 1109. The illustration of a particular order to the blocks does not necessarily imply that there is a required or preferred order for the blocks and the order and arrangement of the block can be varied. Furthermore, it can be possible for some blocks to be omitted.

The above described examples find application as enabling components of:
automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. An apparatus, comprising:
at least one processor; and
at least one non-transitory memory storing instructions that, when executed with the at least one processor, cause the apparatus at least to:
determine a first spatial audio configuration for at least a first space comprising a first acoustic rendering arrangement and determine a second spatial audio configuration for at least a second space comprising a second acoustic rendering arrangement; and
determine a combined spatial audio scene for a combined space comprising at least the first space and the second space wherein the combined spatial audio scene is based on the first spatial audio configuration and the second spatial audio configuration and wherein the combined spatial audio scene is configured to maintain spatial audio continuity in response to a user position changing from the first space to the second space.

2. An apparatus as claimed in claim 1, wherein the instructions, when executed with the at least one processor, cause the apparatus to enable playback of spatial audio signals using the combined spatial audio scene in at least the first space and the second space.

3. An apparatus as claimed in claim 1, wherein the instructions, when executed with the at least one processor, cause the spatial audio to maintain continuity with at least one of:
reducing differences in a main orientation for spatial audio between the first space and the second space;
maintaining spatial audio source direction accuracy; or
maintaining spatial audio energy balance between directions.

4. An apparatus as claimed in claim 1, wherein the spatial audio configurations comprise a main orientation for a user listening to spatial audio in the corresponding space.

5. An apparatus as claimed in claim 1, wherein the instructions, when executed with the at least one processor, determine the combined spatial audio scene based on one or more orientation measures, wherein the orientation measures provide an indication of spatial audio quality at different orientations for a user within the different spaces.

6. An apparatus as claimed in claim 1, wherein the instructions, when executed with the at least one processor, determine the combined spatial audio scene based on one or more deviation values that provide an indication of an allowed difference in spatial audio scenes between the first space and the second space.

7. An apparatus as claimed in claim 1, wherein the instructions, when executed with the at least one processor, determine the combined spatial audio scene based on tracking data relating to one or more users.

8. An apparatus as claimed in claim 1, wherein the instructions, when executed with the at least one processor, determine the combined spatial audio scene based on data indicating a type of content being provided.

9. An apparatus as claimed in claim 1, wherein the instructions, when executed with the at least one processor, determine spatial audio configurations for a plurality of different spaces comprising different acoustic rendering arrangements and determining the combined spatial audio scene for the combined space comprising the plurality of spaces, wherein the combined spatial audio scene is based on the spatial audio configurations for the plurality of different spaces.

10. An apparatus as claimed in claim 1, wherein the instructions, when executed with the at least one processor, determine the combined spatial audio scene with applying different weightings to different spaces.

11. An apparatus as claimed in claim 1, wherein the different spaces comprise different rooms.

12. A method, comprising:
determining a first spatial audio configuration for at least a first space comprising a first acoustic rendering arrangement and determining a second spatial audio configuration for at least a second space comprising a second acoustic rendering arrangement; and
determining a combined spatial audio scene for a combined space comprising at least the first space and the second space wherein the combined spatial audio scene is based on the first spatial audio configuration and the second spatial audio configuration and wherein the combined spatial audio scene is configured to maintain spatial audio continuity in response to a user position changing from the first space to the second space.

13. A method as claimed in claim 12, wherein the spatial audio continuity is maintained with at least one of:
reducing differences in a main orientation for spatial audio between the first space and the second space;
maintaining spatial audio source direction accuracy; or
maintaining spatial audio energy balance between directions.

14-18. (canceled)

19. A method as claimed in claim 12, wherein the spatial audio configurations comprise a main orientation for a user listening to spatial audio in the corresponding space.

20. A method as claimed in claim 12, wherein the combined spatial audio scene is determined based on at least one of:
one or more orientation measures, wherein the orientation measures provide an indication of spatial audio quality at different orientations for a user within the different spaces; or
one or more deviation values that provide an indication of an allowed difference in spatial audio scenes between the first space and the second space.

21. A method as claimed in claim 12, wherein the combined spatial audio scene is determined based on tracking data relating to one or more users.

22. A method as claimed in claim 12, wherein the method is caused to determine spatial audio configurations for a plurality of different spaces comprising different acoustic rendering arrangements and determining the combined spatial audio scene for the combined space comprising the plurality of spaces, wherein the combined spatial audio scene is based on the spatial audio configurations for the plurality of different spaces.

23. A method as claimed in claim 12, wherein the combined spatial audio scene is determined with applying different weightings to different spaces.

24. A method as claimed in claim 12, wherein the different spaces comprise different rooms.

25. A method as claimed in claim 12, wherein the combined spatial audio scene is determined based on data indicating the type of content being provided.
